(19) United States
(12) Patent Application Publication
(10) Pub. No.: US 2014/0149225 A1
(43) Pub. Date: May 29, 2014

(54) Systems and Methods for Determining Advertisements for Display on an Electronic Publishing System

(71) Applicant: WEAVER MOBILE, INC., Santa Clara, CA (US)

(72) Inventors: Hua Ji, Cupertino, CA (US); Wen Wei, Saratoga, CA (US)

(73) Assignee: WEAVER MOBILE, INC., Santa Clara, CA (US)

(21) Appl. No.: 13/689,502

(22) Filed: Nov. 29, 2012

(51) Int. Cl. G06Q 30/02

(52) U.S. Cl. CPC G06Q 30/0269
USPC 705/14.66

(57) ABSTRACT

A method for operating an electronic publishing system to display one or more advertisements, comprising the steps of: receiving user content to be displayed on the electronic publishing system; determining the one or more advertisements as a function of the user content and the user's behavior on the electronic publishing system; displaying the user content on the electronic publishing system in a specific format conducive for display of such user content; and displaying the determined advertisements on the electronic publishing system using the specific format to resemble the user content.

### FIELD OF INVENTION

This invention generally relates to systems and methods for determining advertisements for display on an electronic publishing system and, in particular, to systems and methods for determining advertisements for display on an electronic publishing system based on user content.

### BACKGROUND

An electronic publishing system, such as a social networking system, micro-blogging system, blogging system, online news publisher, social networking aggregation system, etc., that allow users to interact with the system and/or other users of the system typically records the users' activities and content posted by the users. The recorded data may comprise information provided by the user, including age, name, sex, ethnicity, religious beliefs, etc., as well as information gathered by the system related to activities or actions of the user when interacting with other users or the electronic publishing system. The electronic publishing system may then use that information provided by the user and other content from the user to display targeted advertisements to the user via the electronic publishing system.

Advertisers have attempted to leverage this information and content about users of the electronic publishing system by targeting their advertisements to users whose interests are relevant to such advertisements. For example, a social networking website may display banner advertisements for a concert to users who have listed their preference for the performing band in their user profile on the electronic publishing system. However, these attempts are no different than targeting of advertisements that exist in many other contexts. Advertisers have not yet been able to exploit the relationships and connections among members of a social networking website in a meaningful way to present their advertising message to users receptive to a particular targeted advertisement.

The placement of such advertisements frequently occurs along predefined positions on the user interface of the system. Typically, advertising banners and sponsored sections are generally placed in predefined areas of a website. The banners can include targeted advertisements that are triggered by the user's interaction with the respective website. Such targeted advertisements are highly ineffective since many users have trained themselves to avoid viewing such areas of the respective website. The targeted advertisements also do not take into account the content currently displayed on the website to improve the likelihood that a user is interested in a particular targeted advertisement.

Due to the proliferation of mobile devices, many users view websites on small screens of the mobile devices. The advertising banners and sponsored sections from these websites do not properly fit on the small screens for any meaningful viewing by the users. Even for mobile devices with slightly larger screens, the advertising banners and sponsored sections may be too small for users to recognize since the users quickly scroll through the website for specific locations of interest. Thus, advertising banners and sponsored sections are rarely viewed, if at all, on mobile devices.

In more elaborate methods of determining advertisements for display to users of the electronic publishing system, targeted sponsored stories that may be of interest to the user are published to the user. For instance, a user interacting with a social network may post stories or status updates to a live activity stream, such as a news feed. A news feed is a data format typically used for providing users with frequently updated content. Typically sponsors can pay for a static advertisement to be displayed to the user at an adjacent location to the user's news feed on the website of the social network. Furthermore, particular sponsored stories can be directly inserted into the user's newsfeed by republishing the actions of other users that the user is subscribed to for receiving such alerts. For instance, if a user Z is connected to and subscribes to two other users, i.e., user X and user Y, and if user X and Y both “like” a certain product, then that action will be republished on user Z's newsfeed stating that two of user Z's friends have “liked” the product. Unfortunately, users have trained themselves to avoid such unwanted advertisements by simply turning off such notifications or by quickly avoiding any notification in which a product is associated with other connected users. Once again, such methods do not leverage the content currently being displayed to the user to determine the best targeted advertisement to display to the user.

With the advent of micro-blogging websites that allow for the posting of graphic boxes that typically comprise an image and action items that a user can select from to perform various actions, including commenting, “liking” the graphic box, and performing other actions. A micro-blogging website can have several graphic boxes assembled along columns on the website to allow for a user to view such content and post his/her own content. Since these micro-blogging sites have an entirely different format from other social networking websites, the existing technology for determining and displaying targeted advertisements on such websites are not adequate since those existing technologies are only geared toward text based newsfeeds.

For instance, on the Pinterest website (located at web address: www.pinterest.com), a user can organize various images and other content along various graphic boxes that are displayed on the user's homepage on Pinterest. Current art has not been able to leverage such websites to determine targeted advertisements based on the content currently displayed on the homepage of Pinterest. Nor have current art been able leverage the users' posted content in determining targeted advertisements for the users.

Therefore, there exists a need to publish targeted advertisements for an electronic publishing system that will more effectively provide advertisements to the user of the system based on content currently being displayed on the electronic publishing system.

### SUMMARY OF INVENTION

An object of this invention is to provide improved methods and systems for determining user-targeted advertisements for display on an electronic publishing system.

Another object of this invention is to provide methods and systems for determining advertisements for display on an electronic publishing system as a function of the content provided on the electronic publishing system.

Yet another object of this invention is to provide methods and systems for determining advertisements for display on an electronic publishing system that graphically blend in with the graphical content of the electronic publishing system.

Briefly, the present invention discloses methods and systems for operating an electronic publishing system to display one or more advertisements, comprising the steps of: receiving user content to be displayed on the electronic publishing system; determining the one or more advertisements as a function of the user content and the user's behavior on the electronic publishing system; displaying the user content on the electronic publishing system in a specific format conducive for display of such user content; and displaying the determined advertisements on the electronic publishing system using the specific format to resemble the user content.

An advantage of this invention is that methods and systems for determining user-targeted advertisements for display on an electronic publishing system are provided.

Another advantage of this invention is that methods and systems for determining advertisements for display on an electronic publishing system as a function of the content on the electronic publishing system are provided.

Yet another advantage of this invention is that methods and systems for determining advertisements for display on an electronic publishing system that graphically blend in with the graphical content of the electronic publishing system are provided.

### DESCRIPTION OF THE DRAWINGS

The foregoing and other objects, aspects, and advantages of the invention can be better understood from the following detailed description of the preferred embodiment of the invention when taken in conjunction with the accompanying drawings in which:

FIG. 1 illustrates a website of an electronic publishing system of the present invention.

FIG. 2 illustrates a network topology of the present invention for aggregating user content.

FIG. 3 illustrates a flow diagram of the present invention for determining advertisements for display on an electronic publishing system as a function of a user content stream.

### DETAILED DESCRIPTION OF THE PREFERRED EMBODIMENTS

In the following detailed description of the embodiments, reference is made to the accompanying drawings, which form a part hereof, and in which is shown by way of illustration of specific embodiments in which the present invention may be practiced.

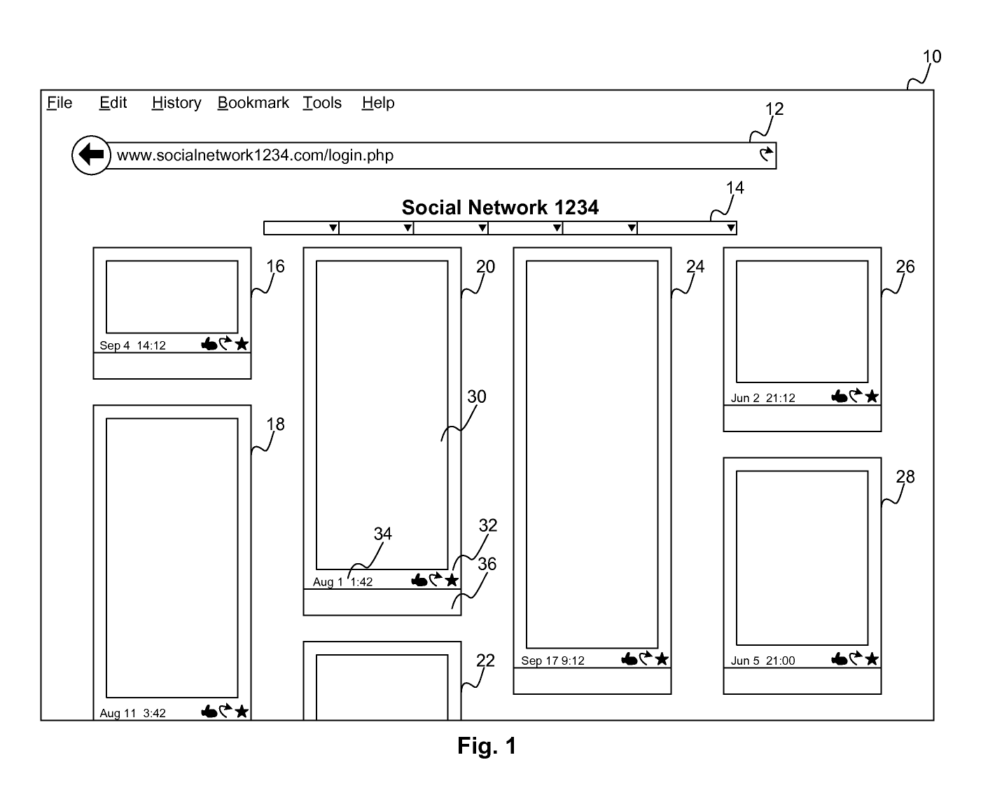

FIG. 1 illustrates a website of an electronic publishing system of the present invention. An electronic publishing system (e.g., a social networking system, micro-blogging system, online news publisher, social networking aggregation system, etc.) (“EPS”) allows for displaying content from various sources in a convenient manner to a user of the EPS. Generally, content is accessible by the user via a website of the EPS. The user of the EPS can access the website through a network enabled electronic device, e.g., personal computer, laptop, smart phone, computing tablet, etc. The content of the EPS can be formatted in a specific format conducive for display of such content on the network enabled electronic device.

The content on the website of the EPS can be generated from the user's actions or other user's actions. For instance, the user can post images, texts, other information, or combinations thereof. Alternatively, other users can post images, texts, other information, or combinations thereof for the user to access. Typically, actions of the user are listed in a text based newsfeed for the user to quickly review. In micro-blogging sites, the action can be posted in a more graphically pleasing format.

In an example, the user can login to a website 10 of an EPS that has customized content for the user to view. In that website 10, the user can view content posted by the user and view posted content from other users. The user can also select which other users to retrieve posted content from or not retrieve posted content from; the other users that the user receives content from can be referred to as “friends”. The website 10 of an electronic publishing system of the present invention can be located at a web address, e.g., in address bar 12. The website 10 can also comprise of a navigation drop down menu 14 and various graphical boxes 16-28 aligned along various columns of the website 10.

Each of the graphical boxes 16-28 can contain an image and/or text, action icons, a date stamp, a commenting bar, and other content and action items for the user. For instance, the graphical box 20 can comprise one or more images, text, and/or other content displayed in an area 30, action icons 32, a date stamp 34, and a comment bar 36. The images, text, and/or other content in the area 30 can be posted by the user or other users. The date stamp 34 states when the images and/or text were posted. The action icons 32 can provide various functionalities to the users of the EPS, including “liking” the posted information and bookmarking the posted information for easier retrieval. The comment bar 36 allows for the users of the website to comment on the posted information.

The posted content can be displayed in the graphical boxes 16-28, where the graphical boxes 16-28 are positioned in four columns. The graphical boxes 16-28 can have equal widths with varying heights as displayed on the website 10. The number of columns, widths of the graphical boxes, and heights of the graphical boxes can be automatically adjusted as needed or as programmed when the viewing window of the website 10 is adjusted. For instance, if the website 10 is accessed and viewed from a smart phone, then the website may have only one column of graphical boxes, wherein the graphical boxes fit within the display size of the smart phone. The user of the smart phone can scroll the various graphical boxes by scrolling up and down on the display screen of the smart phone. Additionally, if the website 10 is viewed on a larger screen (e.g., a 24″ screen), then there can be many more columns to position the graphical boxes of the website 10.

The content of the various graphical boxes 16-28 can be categorized and sorted by the EPS. Based on various methods for determining targeted advertisements, a best advertisement can be determined as a function of the user content. The best advertisement can then be inserted in one of the various graphical boxes 16-28 for the user to view. Since the graphical boxes 16-28 have similar widths and appearance, the user will view the graphical box having the targeted advertisement as another user's posting or his/her own posted content. Thus, the determined targeted advertisement can be formatted to resemble the appearance of the user content. As such, the user will pay more attention to the targeted advertisements of the present invention since it is more difficult to determine where the user content is located and where the advertisements are located.

In addition, a slow start algorithm can be used where the targeted advertisements are slowly worked into the user's session on the website 10. When the user first starts browsing on the website 10, targeted advertisements may not be displayed immediately. Instead, the website 10 will determine targeted advertisements for the user based on the user's behavior, e.g., user viewed areas of the website, what the user has clicked on the website, cursor location, and other actions the user may take. After a predefined length of time and/or a number of user actions, the determined targeted advertisements can be worked into the user's session by slowly displaying the targeted advertisements on one or more of the graphical boxes 16-28. Furthermore, a paging based algorithm can be used to gradually display specific sponsored advertisements in one or more of the graphical boxes 16-28, rather than having a predetermined targeted advertisement displayed.

Also, a fast start algorithm can be used where the targeted advertisements are quickly worked into the user's session on the website 10 based on whether any other users, e.g., friends of the user, view a particular targeted advertisement. Typically, the user can have one or more content items, originally displayed on their friends' feed, be displayed in the user's feed on the website 10. If the user's friends select a particular targeted advertisement for viewing or for some other action, that particular targeted advertisement may have a higher probability that the user may want to view that particular targeted advertisement as well. The EPS can display that particular targeted advertisement much earlier in the user's feed than other targeted advertisements. Also, if the particular targeted advertisement is viewed by a predefined number of friends, then the particular targeted advertisement can have even more priority to be displayed on the website 10 in the user's feed. Thereby, certain targeted advertisements can be quickly displayed on the website 10 to the user, even on the first page that the user views when logging in to the website 10.

Generally, the probability that the user will view any targeted advertisement on the website 10 increases dramatically since the advertisement is displayed in a graphical box that resembles the graphical boxes for displaying user posted content. Furthermore, since the targeted advertisements are cleverly disguised within the midst of other posted content that are similar in type of subject matter, the user cannot quickly discount a specific area for advertisements or any specific graphical box as an advertisement. Thereby, the probability of the user viewing the targeted advertisements can be increased.

For instance, the graphical boxes 16-28 can be classified under various subject matter categories, e.g., cars, woman clothes, education, local news, local events, common interests, community, sports, business, etc. The targeted advertisements can be embedded in one or more of the graphical boxes 16-28 relating to the same subject matter category. Thus, targeted advertisements can be mixed into other content with similar subject matters.

When the posted content for the website 10 is changed, the targeted advertisement can be changed to match the subject matter of the currently displayed content. For instance, if the website 10 had posted content related to football images and articles, the targeted advertisement can be selected to be football related as well. The football related advertisement is displayed in one of the graphical boxes 16-28. The graphical box for the football related advertisement can be selected by the user to bring up a pop-out window (or graphical box) that has a larger image of the advertisement than as shown on the website 10. If the user clicks on a different tab to bring up another page with different posted content (e.g., the posted content is related to knitting), then targeted advertisement displayed on the website for the user can change to a knitting related advertisement.

Once a targeted advertisement is selected as a function of the posted content, the position of the graphical box with the advertisement can also be placed in various locations of the website 10. For instance, the targeted advertisements can be positioned on the website 10 at random, at locations that best fit the size of the graphical box for the targeted advertisement, at the location of the website that gets the most traffic, user clicks, user views, user related feedback, other user actions, other user behavior, and/or at locations according to any advertisement placement methods.

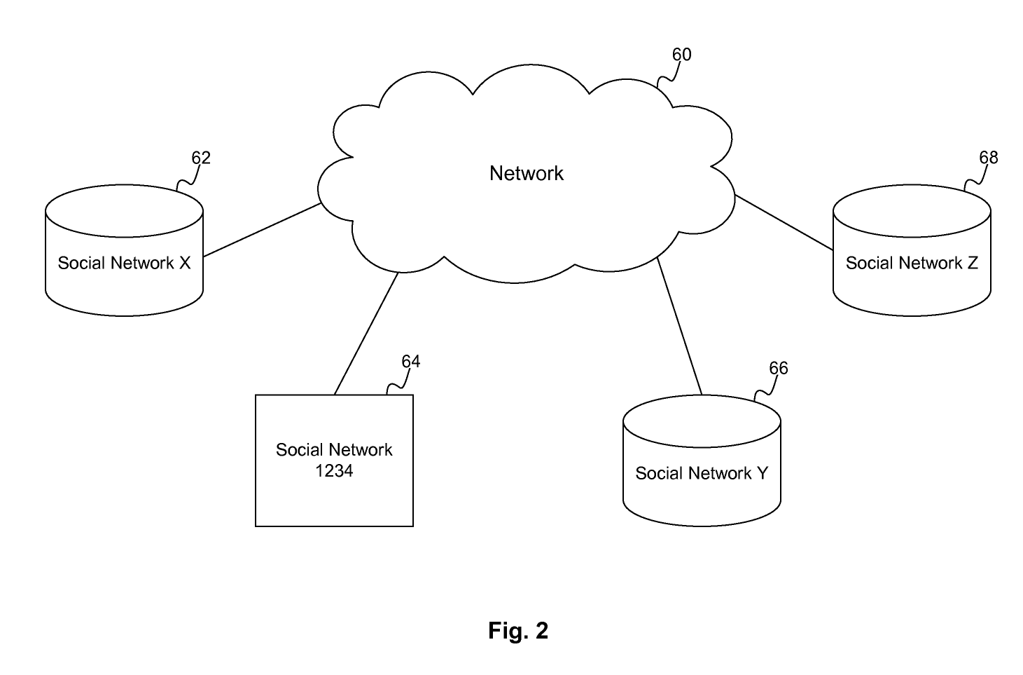

FIG. 2 illustrates a network topology of the present invention for aggregating user content streams. An EPS of the present invention can host posted content by the user. In addition, the EPS can aggregate several user content streams from various other EPS's, e.g., social networks. For instance, the user can access the Social Network 1234. Within the Social Network 1234's website 64, the user can sign in to other social networks X, Y, and Z, which in turn gives Social Network 1234 the necessary authorizations to retrieve the user's content from those other social networks X, Y, and Z. Once logged in to the other social networks X, Y, and Z, Social Network 1234 can retrieve the user's content streams via a network 60 from databases 62, 66, and 68 of social networks X, Y, Z. The user's content streams are then aggregated and displayed on the website for Social Network 1234. A targeted advertisement can be determined based on the aggregated content to be displayed on the Social Network 1234. The determined advertisement and the aggregated content are then displayed on the website 64 of the Social Network 1234 for the user to view.

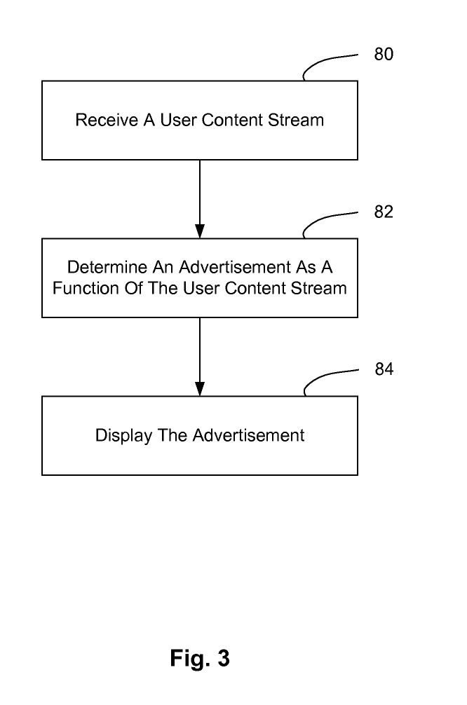

FIG. 3 illustrates a flow diagram of the present invention for publishing advertisements as a function of a user content stream. First, an EPS of the present invention receives a user content stream 80 from one or more social networks and/or its own hosted content. Next, EPS determines an advertisement as a function of the user content stream 82. Lastly, the advertisement is displayed 84 on the website of the EPS. It is important to note that the user content stream can be from one or more various social networking systems, e.g., Facebook, Twitter, Pinterest, etc.

In other embodiments of the present invention, the targeted advertisement can be retrieved from one of the social networking systems and republished on the EPS of the present invention. Additionally, the EPS can host various targeted advertisements to be pushed to the user of the EPS.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for operating an electronic publishing system to display one or more advertisements, comprising the steps of:
receiving user content to be displayed on the electronic publishing system;
determining the one or more advertisements as a function of the user content and the user's behavior on the electronic publishing system;
displaying the user content on the electronic publishing system in a specific format conducive for display of such user content; and
displaying the determined advertisements on the electronic publishing system using the specific format to resemble the user content.

2. The method of claim 1 wherein the user content is aggregated from one or more social networking systems.

3. The method of claim 2 wherein the determined advertisements are published on one of the social networking systems and the determined advertisements are republished on the electronic publishing system.

4. The method of claim 1 wherein the determined advertisements are hosted by the electronic publishing system.

5. The method of claim 1 wherein the user content and the determined advertisements are individually displayed in graphic boxes and wherein the graphic boxes are positioned along multiple columns in a user interface of the electronic publishing system.

6. The method of claim 5 wherein certain ones of the graphic boxes for the determined advertisements are randomly positioned for display in the user interface.

7. The method of claim 5 wherein certain ones of the graphic boxes for the determined advertisements are positioned for display in the user interface according to the user's behavior.

8. The method of claim 5 wherein certain ones of the graphic boxes for the determined advertisements are positioned for display in the user interface according to advertisement placement methods.

9. The method of claim 5 wherein upon selecting one of the certain ones of the graphic boxes for the determined advertisements, the electronic publishing system displays the selected graphic box in a pop-out window.

10. The method of claim 1 wherein the user content and the determined advertisements are images of a same subject matter category.

11. A method for operating an electronic publishing system to display one or more advertisements, comprising the steps of:
receiving user content to be displayed on the electronic publishing system;
determining the one or more advertisements as a function of the user content and the user's behavior on the electronic publishing system;
displaying the user content on the electronic publishing system in a specific format conducive for display of such user content; and
displaying the determined advertisements on the electronic publishing system using the specific format to resemble the user content,
wherein the user content and the determined advertisements are individually displayed in graphic boxes and wherein the graphic boxes are positioned along multiple columns in a user interface of the electronic publishing system, and
wherein the user content and the determined advertisements are images of a same subject matter category.

12. The method of claim 11 wherein the user content is aggregated from one or more social networking systems.

13. The method of claim 12 wherein the determined advertisements are published on one of the social networking systems and the determined advertisements are republished on the electronic publishing system.

14. The method of claim 11 wherein the determined advertisements are hosted by the electronic publishing system.

15. The method of claim 11 wherein certain ones of the graphic boxes for the determined advertisements are randomly positioned for display in the user interface.

16. The method of claim 11 wherein certain ones of the graphic boxes for the determined advertisements are positioned for display in the user interface according to the user's behavior.

17. The method of claim 11 wherein certain ones of the graphic boxes for the determined advertisements are positioned for display in the user interface according to advertisement placement methods.

18. The method of claim 11 wherein upon selecting one of the certain ones of the graphic boxes for the determined advertisements, the electronic publishing system displays the selected graphic box in a pop-out window.

19. A method for operating an electronic publishing system to display advertisements, comprising the steps of:
receiving user content to be displayed on the electronic publishing system, wherein the user content is aggregated from one or more social networking systems;
determining the advertisements as a function of the user content and the user's behavior on the electronic publishing system;
displaying the user content on the electronic publishing system in a specific format conducive for display of such user content; and
displaying the determined advertisements on the electronic publishing system using the specific format to resemble the user content,
wherein the user content and the determined advertisements are individually displayed in graphic boxes and wherein the graphic boxes are positioned along multiple columns in a user interface of the electronic publishing system,
wherein the user content and the determined advertisements are images of a same subject matter category, and
wherein certain ones of the graphic boxes for the determined advertisements are positioned in one or more of the following ways: randomly positioned for display in the user interface; positioned for display in the user interface according to the user's behavior; and positioned for display in the user interface according to advertisement placement methods.

20. The method of claim 19 wherein certain ones of the determined advertisements are hosted by the electronic publishing system, wherein other ones of the determined advertisements are published on one of the social networking systems and the determined advertisements are republished on the electronic publishing system, and wherein upon selecting one of the certain ones of the graphic boxes for the determined advertisements, the electronic publishing system displays the selected graphic box in a pop-out window.
